(19) United States
(12) Patent Application Publication
(10) Pub. No.: US 2011/0086129 A1
(43) Pub. Date: Apr. 14, 2011

(54) IMPROVED POULTRY PRODUCTS

(76) Inventor: Amiram Raz, Ramat Gan (IL)

(21) Appl. No.: 12/996,796

(22) PCT Filed: Jun. 29, 2009
(86) PCT No.: PCT/IL09/00647

§ 371 Date: Dec. 8, 2010

(30) Foreign Application Priority Data
Jun. 30, 2008 (IL) 192542
Dec. 10, 2009 (IL) 202662

(51) Int. Cl. A23K 1/20; A23K 1/18; A23K 1/24; A23L 1/315

(52) U.S. Cl. 426/2; 426/614; 426/644; 426/623; 426/302

(57) ABSTRACT

A method for modifying poultry products with beneficial fatty acids comprising feeding a fowl with a standard feed in which the animal or vegetable oil blend component of the feed is replaced by, or supplemented with, an oil blend consisting of at least 50% fish oil, canola oil (10-30%), soy oil and/or soap stock (0-40%) and linseed oil (0-30%), at total oil levels added to the feed from about 2.5% up to about 7.0%, calculated based on the final feed composition. The modified poultry products obtained maintain the natural smell and taste. Also described are chicken eggs, chicken meat and turkey meat having increased content of monounsaturated fatty acids and reduced content of saturated fatty acids.

### FIELD OF THE INVENTION

The present invention relates to poultry products which are produced for human consumption. Specifically, it relates to a method for modifying poultry products with beneficial fatty acids, wherein the modified poultry products maintain the natural smell and taste for producing eggs and poultry meat, particularly chicken or turkey, having improved health and nutritive values.

### BACKGROUND OF THE INVENTION

The increasing number of seniors in the general population, along with the general trend of consuming healthier food products led to the demand for the development of foods directed to support a long and healthy life. According to the FDA, healthy foods provide, by virtue of the active ingredients they contain, benefits beyond basic nutrition.

Fatty acids consist of the elements carbon, hydrogen and oxygen arranged as a carbon chain skeleton with a carboxyl group (—COOH) at one end. Saturated fatty acids (SFAs) have all the hydrogen that the carbon atoms can hold, and therefore, have no double bonds between the carbons. Monounsaturated fatty acids (MUFAs) have only one double bond. The shortest descriptions of fatty acids include only the number of carbon atoms and double bonds in them. C18:0 means that the carbon chain of the fatty acid consists of 18 carbon atoms, and there are no double bonds in it, whereas C18:1 describes an 18-carbon chain with one double bond in it. If there is one or more double bonds in the fatty acid, it is no longer considered saturated, but rather, mono- or polyunsaturated. Omega poly unsaturated fatty acids are unsaturated fatty acids which have several carbon-carbon double bonds. The omega notation indicates the number of carbons from the terminal methyl carbon, where the first double bond in the chain is present.

The human body can produce all but two of the fatty acids it requires. These two, linoleic acid (LA) and alpha-linpleic acid (ALA), are widely distributed in plant oils. As these omega-3 and omega-6 PUFAs cannot be produced in the body and must be supplied in food, they are termed “essential fatty acids”. The human diet contains much more LA than ALA, thus the conversion of LA to C20:4 omega-6 arachidonic acid (ARA) predominates in comparison to the synthesis of C20:5 eicosapentaenoic acid (EPA, omega-3) and C22:6 docosahexaenoic acid (DHA, omega-3) from ALA. EPA and DHA are two omega-3 fatty acids that are essential components of all cell membranes and critical for human health. DHA comprises approx. 30% of the fatty acids in the brain and retina and is a significant constituent in all other tissues and cells. DHA is therefore essential for normal brain and eye function and overall body health in humans. ARA, EPA and DHA are also used to produce hormone-like substances that regulate a wide range of functions, including blood pressure, blood clotting, blood lipid levels, immune response, and inflammation response to injury or infection.

Although the human body can convert, to a limited extent, ALA into the omega-3 fatty acids EPA and DHA, this convertion is not sufficient to fulfill the nutritional daily requirement of fatty acids. Furthermore, the limited synthesis of EPA from ALA within the body is slowed down by competition with the synthesis of ARA from LA. Excess cellular ARA, whether derived from de-novo synthesis from dietary LA or consumed in the diet (mainly from animal inner organs and meat), limits the de-novo synthesis of DHA and EPA from ALA. The sum effects of these metabolic limitations is that in practical terms DHA is a vitamin-type nutrient and is required in the food of people consuming the western-type diet. Thus the entry and accumulation of EPA and DHA in human tissues is more effective when they are obtained directly from the food and when the dietary amounts of the competing omega-6 fatty acids LA and ARA are not in large excess over those of EPA and DHA Oily fish and fish oils are rich in EPA and DHA (termed omega-3 highly-unsaturated fatty acids, or HUFA) and therefore serve as an excellent source to fulfill the nutritional need for these fatty acids.

While vegetable or plant polyunsaturated oils containing omega-6 fatty acids such as LA and omega-3 acids such as ALA have some beneficial properties, it has been found that dietary intake of fish and fish (marine) oils, containing substantial omega-3 polyunsaturated fatty acids, such as EPA and DHA, significantly reduce triglycerides level in blood and the likelihood of cardiovascular disease. In the human body, the plant-derived omega-3 fatty acid ALA is only minimally converted to EPA and almost none to DHA. Therefore, supplementation of the human diet with ALA-rich plant oils, or the plant seeds themselves, does not lead to significant increases in the levels of EPA and DHA in blood and tissues.

It is now well accepted that high levels of dietary saturated fatty acids and cholesterol increase the risk for cardiovascular and circulatory diseases such as atherosclerosis, myocardial infraction and stroke as well as hypertension and thrombosis. Significantly, populations in which the level of saturated fat in the diet is low, and the level of omega-3 polyunsaturated fat is high, such as the Greenland and American Eskimo, the likelihood of coronary heart disease is greatly reduced compared to the population of mainland United States, in which the dietary intake of saturated fats is high and that of omega-3 oils and foods is low. The composition of the human diet in the western world (US, Canada, Western and Central Europe, Israel) has changed gradually over the past 60 years and is manifested by increased consumption of omega-6 PUFA in parallel with a significant decline in the consumption of saturated animal fat and lard. This change is advocated by the American and European heart associations and is credited, at least in part, with the significant drop in cardio-vascular diseases in the Western world population over the last 50-60 years. However, this dietary change produced a concurrent reduction in the consumption of omega-3 HUFA, often below the recommended dietary intake of DHA and EPA. To overcome this, the medical and health organizations in the western world countries have recently adopted strong recommendations encouraging the public to increase the consumption of fish and fish oils to achieve a significant reduction in blood lipids (triglycerides) level and in the probability for developing cardiovascular diseases.

In line with the above, the medical community in recent years has also recommended adopting the “Mediterranean diet” (formulated according to the food consumed by the inhabitants of the island of Crete) as a means for reducing low density lipoproteins (LDL) oxidation and thus coronary heart disease. The Mediterranean diet is characterized by increased consumption of olive oil which is rich in the monounsaturated fatty acids, as well as the intake of omega-3 HUFA-containing fish.

The beneficial effect of high dietary oleic acid in protecting circulating blood LDL against oxidation led to efforts to develop foods and diets high in oleic acid and in fish-derived EPA and DHA.

Chicken eggs are recognized as an excellent source of convenient, low cost dietary protein as well as minerals in a highly digestible form. However, because of the relatively high concentration of cholesterol in the egg yolk, the recommended medical advice was, for many years, to limit egg consumption. Consequently, considerable research effort has been directed towards producing an egg with reduced quantities of cholesterol as well as saturated fatty acids.

The goal of modifying poultry eggs and meat to obtain healthier products may be achieved by introducing supplementary food ingredients into the chickens feed.

One approach found in U.S. Pat. No. 5,897,890 was the addition of flaxseeds or flaxseed oil to the hens feed. This approach resulted in eggs substantially enriched with ALA, but only minimally enriched with the desirable DHA or EPA. The egg produced according to U.S. Pat. No. 5,897,890 contained DHA (65-75 mg) and no EPA, but still had high levels of saturated fatty acids, a component considered to be associated with increased risk of arteriosclerosis and coronary heart disease, and therefore nutritionally less desirable. When the manufacturers of these eggs tried to claim cardiovascular health benefits due to the higher content of “omega-3 fatty acids” in the eggs, the Food and Drug Administration (FDA) issued a clear statement rejecting such claims as being totally unsubstantiated (Docket No. 2004Q-0072, dated Apr. 5, 2005). In addition, the FDA pointed out that cardiovascular benefits of omega-3 poly-unsaturated fatty acids (PUFA) were demonstrated only for EPA and DHA. Notably, ALA was not included in this category.

U.S. Pat. No. 4,918,104 relates to a method for increasing omega-3 PUFA in poultry by administering to the poultry a feed comprising a fish product such as Menhaden fish oil or alternatively fish meal. U.S. Pat. No. 4,918,104 does not provide hedonic sensory data for the chicken meat from broilers fed a diet comprising 10% Menhaden oil, but discloses such analysis for a feed comprising 10% fish meal, reporting that the chicken had a fishy taste which some defined as awful.

Other publications try to confront the problem of the smell and taste of chicken products from poultry fed with fish oil by using low levels of fish oil or blends of fish oil and vegetable oil, however, the obtained products contain only low levels of EPA and DHA. For example, WO 95/21539 relates to a method for the production of eggs having increased omega-3 fatty acid content by feeding the hens with a feed comprising only 1.5%-2.5% mackerel oil with the addition of 1%-4% linseed oil, an antioxidant and vitamin E.

U.S. Pat. No. 5,133,963 relates to a poultry feed comprising Menhaden oil and enriched water which contain additional ingredients.

A different approach, disclosed in U.S. Pat. No. 6,054,147, was to feed broilers with an alga that has been modified by molecular biology techniques to produce substantial amounts of DHA. U.S. Pat. No. 6,054,147 emphasizes the benefits of using algal DHA and not fish oil-derived DHA and states that fish oil is notoriously unstable and imparts undesired flavor and taste. It therefore recommends limiting its use in chicken feed in order to prevent its oxidation and the development of unpleasant flavors and odors. Therefore, according to U.S. Pat. No. 6,054,147, feeding chickens with more than 2% fish oil would render the chicken meat un-edible. Furthermore, the publication describes a feeding regimen for feeding chicken (broilers), wherein the content of omega-3 highly unsaturated fatty acids (HUFA) in the feed is higher in the late phase of the growth than in the early phase, with the strict limitation that the maximal concentration of any low quality omega-3 HUFA source oil is less than 2% by weight of the feed.

In U.S. Pat. No. 6,156,351, hens were fed a standard feed mixture comprising low PUFA supplemented with vitamin E, iodine and carotenoids, to produce an egg enriched with these three ingredients.

U.S. Pat. No. 6,103,276 provides a method for obtaining eggs and chicken meat containing increased levels of LA and ALA, by feeding chicken with whole flaxseed, soybean oil and grit.

Finally, in a very recent pre-publication entitled “the effect of feeding Soybean oil enriched with C18:4 n-3 to broilers on the deposition of n-3 fatty acids in chicken meat” by C. Rymer, G. F. Hartnell and D. I. Givens, published online November 2010 in the British Journal of Nutrition, reports that the 18:4 n-3 (abbreviated SDA) fatty acid provided in a high content in the broilers feed was significantly converted to EPA (˜16-18%) but not to DHA.

In summary, the prior art does not provide a commercially feasible, low-cost method for producing modified poultry eggs and meat which are enriched in both DHA and EPA as well as in oleic acid, yet low in ARA and LA, and at the same time exhibiting the smell and taste of the corresponding non-modified chicken products. Furthermore, the prior art does not provide a poultry feed composition comprising a low cost fish-derived oil, with high nutritional values for producing poultry eggs and meat that are relatively rich in both DHA and EPA, as well as in omega-9 fatty acids, and at the same time contain less saturated fatty acids.

It is therefore an object of the present invention to provide a method for producing poultry products with beneficial health and nutritive values, which reside in their unique fatty acids composition and possessing the same odor and flavor as non-modified products.

It is another object of the invention to provide poultry products with reduced content of saturated fatty acids together with increased content of omega-3 HUFA.

It is another object of this invention to provide a method for producing poultry products rich in DHA, EPA and oleic acid, and low in ARA.

It is another object of the present invention to provide poultry feeds for the production of chicken and turkey eggs and meat that are rich in DHA, EPA and oleic acid, and low in ARA.

Another object of the present invention is to provide poultry feed composition comprising omega-3/omega-9 fish-derived oil, for producing modified poultry eggs and poultry meat.

It is a further object of the present invention to provide a method for modifying poultry products by feeing fowls with a poultry feed composition comprising omega-3/omega-9 fish-derived oil, containing high levels of omega-3 HUFA and omega-9 mono-unsaturated fatty acids, and low levels of omega-6 PUFA.

Another object of the present invention is to provide modified poultry eggs and meat with no fishy smell or taste.

### SUMMARY OF THE INVENTION

In one aspect, the present invention relates to a method for modifying poultry products with beneficial fatty acids, comprising feeding a fowl with a standard feed in which the animal or vegetable oil blend component of the feed is replaced by, or supplemented with, an oil blend consisting of least 50% fish oil, canola oil (10-30%), soy oil and/or soap stock (0-40%) and linseed oil (0-30%) at oil levels added to the feed in the range of 2.5% -7.0%, calculated based on the final feed composition. The modified poultry products obtained by using the method of the present invention maintain the natural smell and taste of non-modified products.

According to a specific embodiment of the invention the content of fish oil is 50-90% of the total oil added to the feed and the oil is a herring-based fish-derived oil, characterized by a fatty acids composition of at least 9% docosahexaenoic acid (DHA) and at least 7% eicosapentaenoic acid (EPA).

According to one embodiment of the invention the fowl is a chicken and the oil level added to the feed is 2.5%-4.5% for egg-lying hens and 2.7%-4.8% for broilers, calculated on the basis of the final feed composition.

According to another embodiment of the invention the fowl is a turkey and the oil levels added to the feed is from 5.3% up to about 7.0%, calculated based on the final feed composition.

According to a further embodiment of the invention the poultry product is a hens' egg.

According to a further embodiment of the invention the poultry product is poultry meat, inner organs, skin or fat.

In another aspect, the invention relates to a chicken egg containing per 100 g of a de-shelled egg (a) at least 170 mg DHA; (b) at least 2000 mg of oleic acid and (c) no more than 160 mg arachidonic acid (ARA).

In another aspect, the invention relates to a chicken meat containing per 100 g of skinless boneless breast meat (a) at least 12 mg DHA; and (b) at least 16 mg of combined DHA+EPA. The chicken skinless thigh meat produced according to the present invention contains per 100 g of boneless meat (a) at least 22 mg DHA; and (b) at least 37 mg of combined DHA+EPA.

In another aspect, the invention relates to a turkey skinless breast meat containing per 100 g of boneless meat: (a) at least 22 mg DHA; and (b) at least 33 mg of combined DHA+EPA. The turkey skinless thigh meat produced according to the present invention contains per 100 g of boneless meat (a) at least 29 mg DHA; and (b) at least 40 mg of combined DHA+EPA.

In a further aspect, the invention relates to a poultry feed comprising an oil blend consisting of at least 50% fish oil, canola oil (10-30%), soy oil and/or soap stock (0-40%) and linseed oil (0-30%), in admixture with standard poultry feed at added oil levels from about 2.5% up to about 7.0%, in the final feed composition. Specifically, the fish oil employed is a herring-based fish-derived oil, characterized by a fatty acids composition of at least 9% DHA and 7% EPA out of the total fatty acids, and at least 28% monounsaturated fatty acids. Specifically, the poultry feed comprises at least 15% omega-9 mono-unsaturated C20:1 and C22:1 out of the total fatty acids.

Further, the standard poultry feed comprises corn meal (30-40%), soybean meal (30-40%) and wheat-sorghum (18-25%) alone, or in admixture with other acceptable poultry feed ingredients. According to one embodiment of the invention the poultry are broilers and hens. According to another embodiment of the invention the poultry are turkeys.

The terms “standard poultry feed” or “acceptable poultry feed”, as used herein indicates any conventional poultry feed employed in the art. Such feed conventionally comprises one or more of corn meal, soybean meal and wheat-sorghum as major components of the feed and smaller quantities of additional ingredients such as oils, vitamins and minerals.

In another aspect the invention relates to a process for the manufacture of the poultry feed of the invention, comprising the steps of: (a) admixing corn meal, soybean meal, wheat-sorghum and any additional ingredient, with an oil blend comprising fish oil (50-90%), canola oil (10-30%), soy oil and/or soap stock (0-40%) and linseed oil (0-30%); and (b) wetting the mixture and compressing the mixture into nuggets.

According to another aspect the invention relates to a process for the manufacture of a poultry feed, comprising the steps of: (a) admixing corn meal, soybean meal, wheat-sorghum and any additional ingredient with a fraction of an oil blend comprising fish oil (50-90%), canola oil (10-30%), soy oil and/or soap stock (0-40%) and linseed oil (0-30%); (b) wetting the mixture and compressing the mixture into nuggets; and (c) spraying the reminder of the oil blend onto the nuggets.

In another aspect the invention relates to a process for the manufacture of a poultry feed, comprising the steps of: (a) admixing corn meal, soybean meal, wheat-sorghum and any additional ingredient with a fraction of one or more of the components of an oil blend comprising fish oil (50-90%), canola oil (10-30%), soy oil and/or soap stock (0-40%) and linseed oil (0-30%); (b) wetting the mixture and compressing the mixture into nuggets; and (c) spraying the reminder of the oil blend components onto the nuggets.

According to one embodiment, the process of the invention further comprises granulating the nuggets to finer mini-nuggets.

The above and other characteristics and advantages of the invention will be more readily apparent through the following examples.

### DETAILED DESCRIPTION OF THE INVENTION

The present invention provides modified poultry eggs and meat having an increased content of omega-3 HUFAs DHA and EPA and of monounsaturated fatty acids and reduced content of saturated fatty acids and omega-6 fatty acid ARA, and a method of producing the same. The invention further provides poultry feed compositions and a process for the manufacture thereof.

In one aspect, the present application provides a method for modifying poultry products with beneficial fatty acids, wherein the modified poultry products maintain the natural smell and taste. The method comprises feeding a fowl with a standard feed in which the animal or vegetable fat blend component of the diet is replaced by an oil blend consisting of fish oil (50-90%), canola oil (10-30%), soy oil or soap stock (0-40%) and linseed oil (0-30%) at added oil/fat levels in the diet of up to 7.0%, calculated based on the final feed composition. The fish oil employed according to the present invention is not menhaden oil or mackerel oil. Optionally, the fish oil employed is herring-based fish-derived oil.

In another aspect, the present invention provides poultry feed composition comprising herring-based fish-derived oil. An illustrative example of a suitable oil is the herring-based “certified organic” fish oil, produced by Vereinigte Fischmehle Werke, Cuxhaven, Germany.

The term “herring based” is meant to indicate that the oil mainly consists of oil extracted from herring fish, but may also contain small amounts of oils from other sources.

The fatty acids composition of the herring-based fish-derived oil used in the poultry feed composition of the present invention comprises at least 18% of combined EPA+DHA (omega-3 HUFA's). Such content of omega-3 HUFA is essential for enabling substantial incorporation of the HUFAs into the fowl eggs and meat.

Further, the amount of DHA in the fish oil utilized according to the present invention is higher than the amount of EPA, as DHA is the key omega-3 HUFA, necessary for healthy neuronal function and vision.

According to one embodiment of the invention the herring-based fish-derived oil further comprises omega-9 fatty acids (at least 40% of combined C18:1, C20:1 and C22:1). Specifically, the amounts of the long chain mono-unsaturated fatty acids C20:1 and C22:1 in the oil is at least 28%. In general, C20:1 and C22:1 fatty acids are not produced in the human or fowl's body nor are they stored in the body muscle or fat depot after consuming them in the diet. These fatty acids are primarily metabolized in the human and fowl's body to produce energy via the β-oxidation process by breaking the fatty acid chain into small 2-carbon units called acetyl CoA that is subsequently metabolized to produce cellular energy as ATP. Using the C20:1 and C22:1 mono-unsaturated fatty acids to produce such cellular energy allows the sparing of the essential omega-3 HUFA from being similarly oxidized and lost. Accordingly, inclusion of C20:1 and C22:1 fatty acids in the poultry feed composition ensures that the essential omega-3 HUFAs are largely spared from β-oxidation, thereby allowing their efficient incorporation into the fowl tissues and the egg.

According to a further embodiment, the fish-oil employed contains C16:1/C18:1 mono-unsaturated fatty acids at a total level significantly higher than that of the saturated fatty acids C14:0+C16:0+C18:0. Such change is highly recommended by the American Heart Association and other cardiology clinical groups to reduce atherosclerosis and blood LDL cholesterol and forms the central core of the “Mediterranean diet”, a diet highly recommended nowadays by clinicians and human nutritionists world-wide to reduce cardiovascular disease and adult-type diabetes among the western world population.

According to a still further embodiment, the fish-oil employed contains up to 50 ppm of citric acid in order to reduce auto-oxidation of the oil during its storage and in the process of preparing the final feed composition.

In another aspect, the present application provides a way to obtain modified poultry products by feeding fowls with a poultry feed composition comprising an oil blend that are rich in both omega-3 and omega-9 fatty acids and relatively poor in omega-6 LA.

The term “poultry” as employed herein refers particularly to and egg-laying hen and to chickens grown for meat (broilers or other types) and to turkey grown for meat, and in general to any avian species including goose and ostrich.

The term “chicken meat” as employed herein refers particularly to meat obtained from a chicken or turkey, and in general to any avian species including goose and ostrich. The term “chicken meat” further refers to all parts and organs of the poultry, including meat, inner organs, skin and fat.

It should be noted that the skin surrounding the fowl's meat portions (e.g. breast, thigh, leg and wings) of the fowls fed with the supplemented feeds according to the present invention contains very significant amounts of omega-3 HUFAs DHA and EPA. Yet because the amount of skin left attached to the meat varies according to the practices of slaughter and meat sales in individual countries and areas, and because some customers prefer to eat the meat without the skin attached, the values provided herein refer only to skinless, boneless meat breast and thigh portions.

Reference will be often made herein to “chicken” for the sake of brevity, it being understood that the description applies, mutatis mutandis, to other poultry as well and to fowls in general.

Whenever reference is made herein to “canola oil” the same applies also to other high oleic acid-containing oils, such as high oleic sunflower oil, high oleic soybean oil or high oleic corn oil. Canola (rapeseed) oil is referred to herein specifically, for the sake of brevity.

Whenever reference is made to “fish oil” it should be understood that this term does not include menhaden oil or mackerel oil. As well known to men of the art, the aforementioned two oils are unsuitable for carrying out the invention in light of their strong smell and, therefore, the resulting product is unsuitable for human consumption because of its strong foul taste and smell which are objectionable to a large proportion of the population.

An average chicken shell egg contains 10% shell, 60% albumen and 30% yolk. De-shelled whole egg consists of about 65% albumen and about 35% yolk. The yolk of an average egg contains both saturated and unsaturated fatty acids.

The chicken egg according to the present invention contains, per 100 g de-shelled egg, at least 170 mg DHA, less than 160 mg ARA and an oleic acid content of at least 2000 mg. According to a specific embodiment of the invention, the chicken egg containing per 100 g of a de-shelled egg at least 170 mg DHA; and at least 190 mg of combined DHA+EPA.

The fatty acids composition of the chicken breast meat obtained according to the present invention comprises no less than 2.2% DHA and no less than 3.1% of EPA plus DHA. Calculated per 100 g meat, the broilers' skinless breast meat (boneless) obtained using the specific embodiment, contains no less than 12 mg DHA and no less than 16 mg of combined EPA+DHA. The thigh meat contains no less than 22 mg DHA and no less than 37 mg EPA and DHA.

The fatty acids composition of the turkey breast meat according to the present invention comprises no less than 3.3% DHA and no less than 4.5% of combined EPA+DHA. Calculated per 100 g meat weight, the turkey skinless breast meat (boneless) obtained using the specific embodiment, contains no less than 22 mg DHA and no less than 33 mg EPA+DHA, while the thigh meat contains no less than 29 mg DHA and no less than 47 mg EPA+DHA.

According to a further aspect of the invention, the broilers' breast meat obtained by feeding the omega-3/omega-9 fish-derived oil contains per 100 g meat weight, no less than 16 mg DHA, and no less than 24 mg of combined EPA and DHA. The thigh meat contains no less than 22 mg DHA and no less than 37 mg EPA and DHA. This enrichment is compared to the content in regular chicken breast meat of approx. 3.6 mg DHA and 4.2 mg of combined DHA+EPA in the skinless breast and 3.6 mg DHA and 5.2 mg of DHA+EPA in the thigh, per 100 g meat weight.

The fatty acids composition of the turkey breast and thigh meat obtained using the omega-3/omega-9 fish-derived oil in the feed according to the present invention is also highly enriched with EPA and DHA. Calculated per 100 g meat weight, the turkey skinless breast meat contains no less than 22 mg DHA and no less than 33 mg EPA+DHA, while the thigh meat contains no less than 29 mg DHA and no less than 47 mg EPA+DHA. This enrichment is compared to the content in regular turkey meat of approx. 3.6 mg DHA and 4.1 mg of combined DHA+EPA in the breast and 4.6 mg DHA and 5.5 mg of DHA+EPA in the thigh meat, per 100 g weight.

The present invention provides a method for the production of modified eggs, by feeding egg-laying hens with supplementary ingredients. The feed according to the present invention includes standard hen diet, as listed in Table 1, and has the corresponding ingredients analysis as given in Table 2, in which the animal or vegetable fat/oil blend in the standard diet was replaced by an oil blend consisting of fish oil (50-90%), canola oil (10-30%), soy oil or soap stock (0-40%) and linseed oil (0-30%) at added oil level of 2.5%-4.0% in the diet.

The present invention also provides a method for obtaining modified chicken and turkey meat, by feeding chickens or turkeys grown for meat with supplementary ingredients. The feed according to the present invention includes a feed for growing chickens or turkeys, as listed in tables 4 and 7 respectively, and having the ingredients analysis as given in tables 5 and 8 respectively, and in which the regular animal or vegetable fat (oil) blend in the feed, generally termed “soap stock”, is replaced by an oil blend consisting of fish oil (50-90%), canola oil (10-30%), soy oil and/or soap stock (0-40%) and linseed oil (0-30%) at levels of 3.5%-5.3% (in chicken feed) or 5.3%-7.0% (in the turkey feed).

According to a specific embodiment of the invention, the regular animal or vegetable fat (oil) blend in the feed is partly removed from the feed, which is then supplemented with the oil blend of the invention.

The poultry feed composition of the present invention comprises an oil blend consisting of at least 50% fish oil, canola oil (10-30%), soy oil and/or soap stock (0-40%) and linseed oil (0-30%), in admixture with standard poultry feed at added oil levels from about 2.5% up to about 7.0%, in the final feed composition. The feed composition obtained when the fish oil employed is a herring-based fish-derived oil comprises at least 15% omega-9 mono-unsaturated C20:1 and C22:1 out of the total fatty acids.

The present invention further provides a method for the production of modified eggs, by feeding egg-laying hens with omega-3/omega-9 fish oil based blend as a supplementary ingredient. The feed according to the present invention includes standard hen feed, as listed in Table 10, having the corresponding ingredients analysis as given in Table 11, in which the animal or vegetable fat (oil) blend in the standard feed, generally termed soap sock, is totally or partially replaced by an omega-3/omega-9 mainly fish-derived oil characterized by a substantial content of EPA and DHA (at least 7% and 9% respectively of the total fatty acids), a low but sufficient content of omega-6 PUFA LA and ARA (approx. 5% and 0.6% respectively) and a high content of mono-unsaturated fatty acids (at least 30%), out of which approx. 40% are C20:1+C22:1. The oil blend is added to the hen's feed at levels from 2.5% up to about 4.0% in the feed.

The present invention further provides a method for obtaining modified chicken and turkey meats, by feeding chickens or turkeys grown for meat with an oil blend comprising omega-3/omega-9 fish-oil as a supplementary ingredient. The feed according to the present invention includes a feed for growing chickens or turkeys, as listed in tables 13 and 16 respectively, and having the ingredients analysis as given in tables 14 and 17 respectively, and in which the regular animal or vegetable fat (oil) blend in the feed is replaced in part by the omega-3/omega-9 mainly fish-derived oil, at levels of 2.7%-4.8% (in broilers feed) or 5.3%-7.0% (in turkey feed).

According to one embodiment, at least 50% of the fat (oil) in the final poultry feed composition is omega-3/omega-9 fish-derived oil, with the remainder being plant and/or fat oils (e.g. canola, soybean oil, soap stock, linseed oil, etc.).

According to another specific embodiment of the invention, the inclusion of fish oil containing feed in broiler's diet could be initiated at an age of 20-22 days and continue until slaughter at an age of 39-44 days.

According to a specific embodiment of the invention the inclusion of fish oil containing feed in turkey's diet could be initiated at the age of 7-8 weeks for females and 16 weeks for males, and continue until slaughter of the birds at the approx. weight of 9 Kg of the females and approx. 19 kg of the males.

One aspect of the present invention provides modified poultry eggs and meat having increased content of omega-3 HUFA and reduced content of omega-6 PUFA and HUFA. The invention further provides modified poultry eggs and meat with increased content of monounsaturated fatty acids and reduced content of saturated fatty acids and a method of producing the same.

Poultry supplementary feed compositions known in the art that contain Menhaden oil or fish meal have been shown to impart a strong fishy odor and taste on the chicken meat obtained. In contrast, the fish oil blend utilized in the poultry feed according to the present invention possess very mild fishy qualities and can be added in concentrations of at up to 5.3% for broilers or up to 7.0% for turkey, by weight of the poultry feed, with no fishy smell or taste imparted on the meat obtained.

The present invention further provides processes for the manufacture of the poultry feed. In general, the oil blend according to the present invention, comprising fish oil (50-90%), canola oil (10-30%), soy oil and/or soap stock (0-40%) and linseed oil (0-30%) is admixed with an acceptable poultry feed, comprising corn meal, soybean meal, wheat-sorghum and any additional ingredient. According to a specific embodiment, the oil used for the production of the feed is an omega-3/omega-9 herring-based fish-derived oil. Next, the mixture is wetted, optionally with steam and compressed into nuggets. Optionally, the nuggets are further granulated to finer mini-nuggets.

According to one embodiment, the oil blend is added to the other feed ingredients in one stage. According to another embodiment, the oil blend is added in two or more stages of the feed preparation. According to a further embodiment, the various components of the oil blend are added at different stages of the feed preparation, e.g. the fish oil is added at one stage, and the other oil components are added at another stage in the feed preparation process.

The relative amounts of the three major solid ingredients of fowl feed (corm meal, soybean meal and wheat-sorghum, see examples below) may vary according to the availability and cost of each component, and the level of the oil blend added to the feed and its composition is adjusted accordingly.

Additional supplementary ingredients can be added to the feeds of the present invention, for obtaining poultry eggs and meat enriched with additives such as vitamins, minerals, proteins, antibiotics etc.

### EXAMPLES

### Example 1

Feed for Egg-Laying Hens and Fatty Acid Content of Eggs Produced

This Example illustrates the production of modified eggs according to the present invention.

24 hens, 25 weeks of age, previously fed a commercial laying hen diet, were assigned to 2 experimental dietary groups. The first group continued to receive the standard hen diet listed in Table 1, and the corresponding ingredients analysis as given in Table 2. The second experimental group, of 12 hens, was fed a diet in which the animal or vegetable fat blend in the standard diet was replaced by an oil blend composed of 70% fish oil and 30% canola oil at an added oil level of 4.0% in the diet. The diets were fed initially for 2 weeks without collecting eggs (“adjustment period”) and then continued and the eggs collected daily over the next two weeks. The yolk fatty acids analysis was performed by standard procedures.

There were no significant differences between the two experimental groups in the hens' body weight, egg production, egg weight or egg shell properties. Furthermore, no differences between the groups were detected following sensory tests for appearance, taste and smell.

Fatty acids analysis of the egg yolk lipids, presented in Table 3, revealed highly significant differences among the groups in the fatty acids profile and overall content of DHA, EPA, ARA and oleic acid. The hens that received the modified diet produced egg yolks highly enriched in EPA and DHA, together with an increased level of oleic acid and a reduced level of ARA. Calculated per 100 g de-shelled egg, the modified eggs obtained had a DHA content of 280-300 mg, an ARA content of only 64-70 mg, and an oleic acid content of 2000-2850 mg. These values are in sharp contrast to those observed in control eggs that contained, per 100 g deshelled egg, 44-54 mg DHA, 160-220 mg ARA and 1850-1940 mg oleic acid.

The experiment was repeated with 4 different feeds containing 4 different levels of added oil blends comprising 70-90% fish oil and 10-30% canola oil, with compatible results.

TABLE 1
Hens' diet ingredients

| Ingredient | Weight % |
|---|---|
| Corn Meal | 48.30 |
| Soybean Meal | 19.00 |
| Wheat (11.5% protein)- | 9.90 |
| Sorghum (9.1% protein) | |
| Limestone | 9.00 |
| Sunflower Meal | 8.00 |
| Dicalcium Phosphate | 1.00 |
| Vitamin Mix | 0.70 |
| Alimet | 0.11 |
| Oil Blend | 4.0 |

TABLE 2
Hens' diet-nutritional information

| Nutrient | Content |
|---|---|
| Metabolized Energy | 2775 Kcal/Kg |
| Protein | 16.81% |
| Calcium | 3.87% |
| Phosphorus | 0.56% |
| Available Phosphorus | 0.28% |
| Sodium | 0.17% |
| Salt | 0.33% |
| Linoleic | 1.05% |
| Fiber | 3.13% |
| Methionine | 0.39% |
| Sulfur | 0.58% |
| Lysine | 0.80% |
| Arginine | 1.13% |
| Tryptophan | 0.19% |
| Leucine | 1.44% |
| Isoleucine | 0.67% |
| Valine | 0.79% |
| Phenylalanin | 0.77% |
| Aromatic aa | 1.42% |
| Histidine | 0.46% |
| Threonine | 0.63% |
| Fat | 6.2% |
| Choline | 1309.35 ppm |
| Xanthophyl | 8.8 ppm |
| Potassium | 0.7% |

TABLE 3
Key fatty acid content of control egg vs. modified egg

Fatty Acid Content
(mg/100 g de-shelled egg)

| Fatty Acid | Control Egg | Modified Egg |
|---|---|---|
| ARA | 160-220 | 64-70 |
| DHA | 44-54 | 280-300 |
| Oleic Acid | 1850-1940 | 2000-2850 |

### Example 2

Feed for Chickens Grown for Meat and the Fatty Acid Content of the Meat Obtained

This example illustrates the production of modified chicken meat according to the present invention.

30 young chicks, age 22 days, previously fed a commercial young chicks diet, were assigned to three experimental dietary groups. The first group of 10 chickens continued to receive the standard feed listed in Tables 4 and 5, with soap stock as the oil component, mostly composed of soybean oil and animal fat. The second experimental group, also consisting of 10 chickens, received a feed in which the soap stock was replaced by 4.43% oil blend (calculated from the final feed composition), composed of 65% fish oil, 30% canola oil and 5% soy oil, designated as feed 1. The third group received a feed containing an oil blend composed of 50% fish oil, 30% soap stock and 20% canola oil, designated as feed 2. The diets were fed for 3 weeks after which the chickens were sacrificed and meat samples (dark and white portions) were subjected to total lipid extraction, followed by lipids and fatty acid analysis.

There were no significant differences between the three experimental groups in food consumption, final body weight or percent of depot body fat. Furthermore, no differences between the experimental groups were observed in taste, smell and overall appearance of the meat.

TABLE 4
Broilers' diet ingredients

| Ingredient | Weight % |
|---|---|
| Corn Meal | 33.00 |
| Soybean Meal | 30.60 |
| Wheat (11.5% protein)- | 28.30 |
| Sorghum (9.1% protein) | |
| Oil Blend | 4.43 |
| Dicalcium Phosphate | 1.24 |
| Limestone (CaCO₃) | 1.20 |
| Vitamin Mix | 0.50 |
| Alimet (85) | 0.28 |
| Sodium Bi-Carbonate | 0.20 |
| L-Lysine Sulphate | 0.12 |
| Calperona P | 0.10 |

TABLE 5
Broilers' diet-nutritional information

| Nutrient | Content |
|---|---|
| Metabolized Energy | 3150 Kcal/Kg |
| Protein | 19.8% |
| Calcium | 0.96% |
| Phosphorus | 0.59% |
| Sodium | 0.17% |
| Salt | 0.33% |
| Fat | 6.2% |

Fatty acids analyses of the broilers meat key fatty acids revealed highly significant differences among the experimental groups in the fatty acids profile and overall content of EPA+DHA vs. ARA, as well in the oleic acid content. The chicken skinless breast meat obtained from the group supplemented in their diet with the fish oil-canola oil-soy oil blend (feed 1) was highly enriched in EPA and DHA, as well as in oleic acid and had a reduced level of ARA. The meat fatty acid composition consisted of 5.9-8.0% DHA, combined EPA+DHA of 8.5-11.1%, and only 3.0-4.2% ARA.

As demonstrated in Table 6, calculated per 100 g meat weight, the chicken meat (boneless) obtained from the group supplemented with feed 1 contained 25-30 mg DHA, 35-46 mg of combined EPA+DHA, 170-220 mg oleic acid, and only 11-13 mg ARA. Significantly, the meat obtained is highly enriched in oleic acid (oleic to LA ratio of approx. 3). This is in sharp contrast to the fatty acids content of meat from the control group which had, per 100 g weight, 4.4-4.6 mg DHA, 5.2-5.5 mg EPA+DHA, 28.0-30.2 mg ARA and 100-105.2 mg of oleic acid, with the resulting ratio of oleic acid to LA of only 0.9-1.0. A smaller increase in DHA, EPA+DHA and oleic acid values, accompanied by a milder reduction in ARA, were seen in the meat of chickens supplemented with feed 2, compared to the results of the group on feed 1.

A smaller content of DHA was also found in another experiment, in which the broilers were fed a diet similar to feed 1, but with only 3.5% oil blend added to the feed instead of 4.43%.

TABLE 6
Key Fatty Acid Content of chicken breast meat (without fat and
skin) from broilers fed control diet vs. modified diets

| | Fatty Acid | | |
|---|---|---|---|
| | Content (mg/100 g breast meat) | | |
| Fatty Acid | Control | Feed 1 | Feed 2 |
| ARA | 28.0-30.2 | 11-13 | 19-21 |
| DHA | 4.2-4.6 | 25-30 | 12-15 |
| EPA + DHA | 5.0-5.5 | 35-46 | 16-20 |
| Oleic Acid | 100-107.7 | 170-220 | 130-145 |

### Example 3

Feed for Turkeys Grown for Meat and the Fatty Acid Content of the Meat Obtained

This example illustrates the production of modified turkey meat according to the present invention.

30 young turkey females, age 40-42 days, previously fed a commercial young turkey diet, were assigned to three experimental dietary groups. The first group of 10 turkeys continued to receive the standard diet for growing turkey listed in Tables 7 and 8, with the oil blend being mostly soybean oil and animal fat. The second experimental group, also consisting of 10 turkeys, received a diet in which the standard fat and oil blend was replaced by 7.0% oil blend, calculated from the final feed composition, composed of 70% fish oil and 30% canola oil, designated as feed 3. The third group of 10 birds receiving a feed containing an oil blend composed of 50% fish oil, 20% soap stock and 30% canola oil, designated as feed 4. The diets were fed for 6 weeks after which the turkeys were sacrificed and meat samples were subjected to total lipid extraction, followed by lipids and fatty acid analysis.

There were no significant differences between the control group and the two experimental groups in food consumption, final body weight or percent of depot body fat. Furthermore, no differences between the control and the experimental groups were observed in taste, smell and overall appearance of the fresh meat as well as the cooked meat.

TABLE 7
Turkeys' diet- ingredients

| Ingredient | Weight % |
|---|---|
| Soya Meal - 46.5% protein | 37.7 |
| Corn - 7.5% protein | 34.7 |
| Sorghum - 9.5% protein | 10 |
| Sunflower Meal - 36% protein | 4.8 |
| Oil Blend | 7.0 |
| Dicalcium Phosphate | 3.0 |
| Limestone (CaCO3) | 1.2 |
| Vitamin Mix (starter + growth) | 0.8 |
| Alimet (85) | 0.25 |
| L-Lysine Sulphate | 0.33 |
| Calperona P | 0.2 |
| L-Threonine | 0.03 |

TABLE 8
Turkeys' diet- nutritional information

| Nutrient | Content |
|---|---|
| Metabolized Energy | 3125 Kcal/Kg |
| Protein | 23 |
| Ash | 7.7 |
| Cellulose | 2.9 |
| Calcium | 1.3 |
| Phosphorus | 0.95 |
| Sodium | 0.15 |
| Salt | 0.39 |
| Fat | 8.4 |

Fatty acids analyses of the turkeys' skinless breast meat revealed highly significant differences among the experimental groups in the fatty acids profile and overall content of EPA+DHA vs. ARA as well in the oleic acid content. The meat obtained from group of feed 3 was highly enriched in EPA and DHA, as well as in oleic acid and had a reduced level of ARA. The meat fatty acids composition consisted of 12.77-15.19% DHA, combined EPA+DHA of 16.58-21.08%, only 4.87-6.34% ARA, and an oleic acid to LA ratio of about 1.5. The corresponding values for feed 4 were 7.29-9.87% DHA, 8.88-11.92% EPA+DHA and 10.04-12.89% ARA and an oleic-LA ratio of about 1.

Table 9 presents the fatty acid content of the turkey meat obtained from the three experimental groups, calculated per 100 g skinless breast meat. The meat from the group fed with feed 3 contained 43-51 mg DHA, 61-78 mg of combined EPA+DHA, 73-82 mg oleic acid, and only 23-27 mg ARA. This is in sharp contrast to the fatty acids content of meat from the control turkey group which had, per 100 g weight, 3.7-4.2 mg DHA, 4.2-4.9 mg EPA+DHA, 51-62 mg oleic acid and 33.5-39.8 mg ARA. Furthermore, the turkey breast meat from the experimental group of feed 3 contained 23% less saturated fat (i.e. the sum of palmitic and stearic acids) as compared to the meat from the control group. Also, as seen in Table 9, the fatty acids values in the meat of turkeys supplemented with feed 4 changed more moderately from the control group values, as compared to the results of the group of feed 3.

Finally, a somewhat smaller content of DHA and EPA was also found in another experiment in which the turkeys were fed a diet similar to that described in feed 3, but with only 5.3% oil blend added to the feed instead of 7.0%.

TABLE 9
Key fatty acids content of skinless breast meat from fowls fed
control vs. modified feeds

| | Fatty Acid Content | | |
|---|---|---|---|
| | (mg/100 g breast meat) | | |
| Fatty Acid | Control | Feed 3 | Feed 4 |
| ARA | 33.5-39.8 | 23-27 | 29-32 |
| DHA | 3.7-4.2 | 43-51 | 27-33 |
| EPA + DHA | 4.2-4.9 | 61-78 | 37-44 |
| Oleic Acid | 51-62 | 73-82 | 65-71 |

### Example 4

Feed for Egg-Laying Hens and Fatty Acid Content of Eggs Produced by Using Herring-Based Omega-3/Omega-9 Fish-Derived Oil.

This Example illustrates the use of herring-based omega-3/omega-9 fish-derived oil for the production of modified eggs according to the present invention. Thirty two hens, 28 weeks of age, which were on a standard commercial egg laying hen diet, were assigned to two experimental dietary groups. The first group, consisting of 16 hens (control group), continued to receive the standard hen diet, its composition listed in Table 10, with the corresponding ingredients analysis shown in Table 11. The second group, consisting of 16 hens, received a feed in which the animal or vegetable fat blend in the standard feed was replaced by an omega-3/omega-9 herring-derived fish oil blend composed of 90% herring oil and 10% canola oil at a level in the diet of 2.5%. The feeds were fed initially for 10 days without collecting eggs (“adjustment period”) and then continued with the eggs collected daily over the next two weeks. The yolk fatty acids analysis was performed by standard procedures.

There were no major differences between the control group and the experimental group in egg production, egg weight or egg shell properties. Even more significantly, there were no significant differences between the groups in tests for appearance, taste and smell.

Fatty acids analysis of the egg yolk lipids, presented in Table 12, revealed highly significant differences among the groups in the fatty acids profile and overall content of DHA, EPA and ARA. The hens that received the modified feed, containing the fish oil, produced egg yolks highly enriched in EPA and DHA, and reduced levels of ARA. Calculated per 100 g de-shelled egg, the modified eggs contained 190-220 mg DHA and only 110-138 mg ARA. Significantly, these values of DHA and ARA were very different from those observed in control eggs which contained only approx. 44-54 mg DHA, and considerably more ARA (188-202 mg). This experiment was repeated three times with compatible results.

TABLE 10
Hens' diet ingredients

| Ingredient | Weight % |
|---|---|
| Corn Meal | 49.80 |
| Soybean Meal | 19.00 |
| Wheat (11.5% protein) - | 9.90 |
| Sorghum (9.1% protein) | |
| Limestone | 9.00 |
| Sunflower Meal | 8.00 |
| Dicalcium Phosphate | 1.00 |
| Vitamin Mix | 0.70 |
| Alimet | 0.11 |
| Oil Blend | 2.5 |

TABLE 11
Hens' diet-nutritional information

| Nutrient | Content | |
|---|---|---|
| Metabolized Energy | 2775 | Kcal/Kg |
| Protein | 16.81% | |
| Calcium | 3.87% | |
| Phosphorus | 0.56% | |
| Available Phosphorus | 0.28% | |
| Sodium | 0.17% | |
| Salt | 0.33% | |
| Linoleic | 1.05% | |
| Fiber | 3.13% | |
| Methionine | 0.39% | |
| Sulfur | 0.58% | |
| Lysine | 0.80% | |
| Arginine | 1.13% | |
| Tryptophan | 0.19% | |
| Leucine | 1.44% | |
| Isoleucine | 0.67% | |
| Valine | 0.79% | |
| Phenylalanin | 0.77% | |
| Aromatic aa | 1.42% | |
| Histidine | 0.46% | |
| Threonine | 0.63% | |
| Fat | 6.2% | |
| Choline | 1309.35 | ppm |
| Xanthophyl | 8.8 | ppm |

| | |
|---|---|
| Potassium | 0.7% |

TABLE 12
Key fatty acid content of control egg vs. modified egg

Fatty Acid Content
(mg/100 g de-shelled egg)

| Fatty Acid | Control Egg | Modified Egg |
|---|---|---|
| ARA | 180-220 | 110-138 |
| DHA | 44-54 | 190-220 |

### Example 5

Feed for Chickens Grown for Meat and the Fatty Acid Content of the Meat Obtained by Using a Herring-Based Omega-3/Omega-9 Fish-Derived Oil

This example illustrates the use of herring-based omega-3/omega-9 fish-derived oil for the production of modified chicken meat according to the present invention.

Thirty two young chicks, aged 20 days, which were on a standard commercial young chick's diet, were assigned to two experimental dietary groups. The first group of 16 chickens (control group) received the feed listed in Tables 13 and 14, with soap stock (composed mainly of soybean oil and animal fat) as the oil component. The second group of young broilers, also consisting of 16 chickens, received a feed in which the oil blend consisted of 50% herring-based fish oil, 10% canola oil and 40% soap stock at a level of 4.4% total oil added (calculated from the final feed composition). The diets were fed for 22 days, after which the chickens were sacrificed and meat samples were processed by total lipid extraction and analyzed for fatty acid content.

No significant differences were observed between the control and the experimental group in food consumption, final body weight or percent of depot body fat. Furthermore, no differences between the experimental groups were observed in taste, smell and overall appearance of the meat.

Fatty acids analyses of the broilers' meat (breast and thigh) revealed highly significant differences among the experimental groups in the fatty acids composition and specifically the content of EPA+DHA vs. ARA. The meat from the group supplemented with the fish oil-soap stock blend was highly enriched in EPA and DHA, and had a reduced level of ARA. Further, the fatty acids content in the thigh meat was substantially higher than in the breast meat. As seen in Table 15, calculated per 100 g skinless breast meat, the meat from the fish oil-fed chicken (modified chicken) contained 16-18 mg DHA, 21-24 mg of combined EPA+DHA, and only 22-25 mg ARA. This is in contrast to the fatty acids content of the breast meat from the control group which had, per 100 g weight, approx. 5 mg DHA, 6 mg of combined EPA+DHA and 29-31 mg ARA.

TABLE 13
Broilers' diet ingredients

| Ingredient | Weight % |
|---|---|
| Corn Meal | 33.00 |
| Soybean Meal | 30.66 |
| Wheat (11.5% protein) - | 28.30 |
| Sorghum (9.1% protein) | |
| Oil Blend | 4.40 |
| Dicalcium Phosphate | 1.24 |
| Limestone (CaCO3) | 1.20 |
| Vitamin Mix | 0.50 |
| Alimet (85) | 0.28 |
| Sodium Bi-Carbonate | 0.20 |
| L-Lysine Sulphate | 0.12 |
| Calperona P | 0.10 |

TABLE 14
Broilers' diet-nutritional information

| Nutrient | Content |
|---|---|
| Metabolized Energy | 3150 Kcal/Kg |
| Protein | 19.8% |
| Calcium | 0.96% |
| Phosphorus | 0.59% |
| Sodium | 0.17% |
| Salt | 0.33% |
| Fat | 6.2% |

TABLE 15
Key fatty acid content of chicken skinless breast meat of fowls
fed control vs. modified diets

Fatty Acid Content (mg/100 g meat)

| Fatty Acid | Control Chicken | Modified Chicken |
|---|---|---|
| ARA | 29-31 | 22-25 |
| DHA | 5 | 16-18 |
| EPA + DHA | 6 | 21-24 |

### Example 6

Feed for Turkeys Grown for Meat and the Fatty Acid Content of the Meat Obtained by Using a Herring-Based Omega-3/Omega-9 Fish-Derived Oil

This example illustrates the use of herring-based omega-3/omega-9 fish-derived oil for the production of modified turkey meat according to the present invention.

Twenty four young turkey females, aged 45 days, previously fed a commercial young turkey diet, were assigned to two dietary groups. The first group of 12 turkeys (control group), continued to receive the standard feed for growing turkey listed in Tables 16 and 17, with the oil component in the diet being soap stock. The second group of 12 turkeys received a diet in which the soap stock was replaced by an oil blend composed of 60% herring-based omega-3/omega-9 fish-derived oil, 10% canola oil and 30% soap stock. The diets were fed for five weeks, after which the turkeys were sacrificed and meat samples were subjected to total lipid extraction, followed by lipids and fatty acid analysis.

No significant differences were found between the control and the experimental group in food consumption, final body weight or percent of depot body fat. Furthermore, no differences between the groups were observed in taste, smell and overall appearance of the fresh meat as well as the cooked meat and cured turkey meat.

Fatty acids analyses of the turkeys' fresh meat revealed highly significant differences among the experimental groups in the fatty acids composition and the overall content of EPA+DHA vs. ARA. The turkey meat of the group supplemented with the fish oil-soap stock blend was highly enriched in EPA and DHA and had a reduced level of ARA. Further, the fatty acids content in the thigh meat was substantially higher than in the breast meat. Table 18 presents the fatty acid content of the meat obtained from the two experimental groups, calculated per 100 g skinless meat weight. The modified turkey skinless breast meat contained 23-29 mg DHA, 37-44 mg of combined EPA+DHA, and only 26-30 mg ARA. This is in sharp contrast to the fatty acids content of the turkey breast meat from the control group which had, per 100 g weight, 4.0 mg DHA, 5.0 mg EPA+DHA, and 35-40 mg ARA.

TABLE 16
Turkeys' diet- ingredients

| Ingredient | Weight % |
|---|---|
| Soya Meal - 46.5% protein | 37.7 |
| Corn - 7.5% protein | 34.7 |
| Sorghum - 9.5% protein | 10 |
| Sunflower Meal - 36% protein | 4.8 |
| Oil Blend | 7.0 |
| Dicalcium Phosphate | 3.0 |
| Limestone (CaCO3) | 1.2 |
| Vitamin Mix (starter + growth) | 0.8 |
| Alimet (85) | 0.25 |
| L-Lysine Sulphate | 0.33 |
| Calperona P | 0.2 |
| L-Threonine | 0.03 |

TABLE 17
Turkeys' diet- nutritional information

| Nutrient | Content |
|---|---|
| Metabolized Energy | 3125 Kcal/Kg |
| Protein | 23 |
| Ash | 7.7 |
| Cellulose | 2.9 |
| Calcium | 1.3 |
| Phosphorus | 0.95 |
| Sodium | 0.15 |
| Salt | 0.39 |
| Fat | 8.4 |

TABLE 18
Key fatty acids content of control turkey breast meat vs.
modified turkey breast meat

Fatty
Acid Content (mg/100 g meat)

| Fatty Acid | Control Turkey | Modified Turkey |
|---|---|---|
| ARA | 35-40 | 26-30 |
| DHA | 4.0 | 23-29 |
| EPA + DHA | 5.0 | 37-44 |

While this invention has been described in terms of some specific examples, many modifications and variations are possible. It is therefore understood that within the scope of the appended claims, the invention may be realized otherwise than as specifically described.

1. A method for modifying poultry products with beneficial fatty acids, wherein said modified poultry products maintain the natural smell and taste, comprising feeding a fowl with a standard feed in which the animal or vegetable oil blend component of the feed is replaced by, or supplemented with, an oil blend consisting of at least 50% fish oil, canola oil (10-30%), soy oil and/or soap stock (0-40%) and linseed oil (0-30%), at total oil levels added to the feed from about 2.5% up to about 7.0%, calculated based on the final feed composition.

2. A method according to claim 1, wherein the fowl is a chicken and the oil level added to the feed is 2.5%-4.5% for egg-laying hens and 2.7%-4.8% for broilers, calculated on the basis of the final feed composition.

3. A method according to claim 1, wherein the fowl is a turkey and the oil level added to the feed is from 5.3% up to about 7.0%, calculated on the basis of the final feed composition.

4. A method according to claim 1, wherein the poultry product is an egg.

5. A method according to claim 1, wherein the poultry product is poultry meat, inner organs, skin or fat.

6. The method according to claim 1, wherein the content of fish oil is 50-90% of the total oil added to the feed and the oil is a herring-based fish-derived oil, characterized by a fatty acids composition of at least 9% docosahexaenoic acid (DHA) and at least 7% eicosapentaenoic acid (EPA).

7. A chicken egg modified according to claim 1, containing per 100 g of de-shelled egg:
a. at least 170 mg docosahexaenoic acid (DHA);
b. at least 2000 mg of oleic acid; and
c. no more than 160 mg arachidonic acid (ARA).

8. A chicken skinless breast meat modified according to claim 1, containing per 100 g of boneless meat:
a. at least 12 mg DHA;
b. at least 16 mg of combined DHA+EPA.

9. A chicken skinless thigh meat produced according to claim 1, containing per 100 g of boneless meat:
a. at least 22 mg DHA; and
b. at least 37 mg of combined DHA+EPA.

10. A turkey skinless breast meat produced according to claim 1, containing per 100 g of boneless meat:
a. at least 22 mg DHA;
b. at least 33 mg of combined DHA+EPA.

11. A turkey skinless thigh meat produced according to claim 1, containing per 100 g of boneless meat:
a. at least 29 mg DHA; and
b. at least 40 mg of combined DHA+EPA.

12. A poultry feed composition comprising an oil blend consisting of at least 50% fish oil, canola oil (10-30%), soy oil and/or soap stock (0-40%) and linseed oil (0-30%), in admixture with standard poultry feed at added oil levels from about 2.5% up to about 7.0%, in the final feed composition.

13. The poultry feed composition according to claim 12, wherein the fish oil employed is a herring-based fish-derived oil, characterized by a fatty acids composition of at least 9% DHA and 7% EPA out of the total fatty acids, and at least 28% monounsaturated fatty acids.

14. The poultry feed composition according to claim 12, further comprising at least 15% omega-9 mono-unsaturated C20:1 and C22:1 out of the total fatty acids.

15. A poultry feed according to claim 12, wherein the standard poultry feed comprises corn meal (30-40%), soybean meal (30-40%) and wheat-sorghum (18-25%) alone, or in admixture with other acceptable poultry feed ingredients.

16. A process for the manufacture of a poultry feed according to claim 15, comprising the steps of:
a. admixing corn meal, soybean meal, wheat-sorghum and any additional ingredient with an oil blend comprising fish oil (50-90%), canola oil (10-30%), soy oil and/or soap stock (0-40%) and linseed oil (0-30%); and
b. wetting the mixture and compressing said mixture into nuggets.

17. A process for the manufacture of a poultry feed according to claim 15, comprising the steps of:
a. admixing corn meal, soybean meal, wheat-sorghum and any additional ingredient with a fraction of an oil blend comprising fish oil (50-90%), canola oil (10-30%), soy oil and/or soap stock (0-40%) and linseed oil (0-30%);
b. wetting the mixture and compressing said mixture into nuggets; and
c. spraying the reminder of said oil blend onto said nuggets.

18. A process for the manufacture of a poultry feed according to claim 15, comprising the steps of:
a. admixing corn meal, soybean meal, wheat-sorghum and any additional ingredient with a fraction of one or more of the components of an oil blend comprising fish oil (50-90%), canola oil (10-30%), soy oil and/or soap stock (0-40%) and linseed oil (0-30%);
b. wetting the mixture and compressing said mixture into nuggets; and
c. spraying the reminder of said oil blend components onto said nuggets.

19. A process according to claim 16 further comprising granulating said nuggets to finer mini-nuggets.
